(19) United States
(12) Patent Application Publication
(10) Pub. No.: US 2015/0199076 A1
(43) Pub. Date: Jul. 16, 2015

(54) SYSTEM AND METHOD FOR PROVIDING WEB CONTENT FOR DISPLAY BASED ON PHYSICAL DIMENSION REQUIREMENTS

(71) Applicant: Google Inc., (US)

(72) Inventor: Boris SMUS, San Francisco, CA (US)

(73) Assignee: Google Inc., Mountain View, CA (US)

(21) Appl. No.: 13/769,218

(22) Filed: Feb. 15, 2013

(51) Int. Cl. G06F 3/0481

(52) U.S. Cl. CPC G06F 3/0481

(57) ABSTRACT

A system and a method for providing web content for display are provided. An indication to display a web element on a display interface of an electronic device is received. A physical dimension requirement for the web element is received. One or more physical dimensions of the display interface of the electronic device are obtained in response to receiving the indication. The web element is displayed based on the one or more physical dimensions of the display interface of the electronic device and on the received physical dimension requirement of the web element.

### BACKGROUND

The subject technology generally relates to providing web content for display, and in particular, relates to providing a properly sized web content for display.

A visual representation of a web element may have physical dimensions that are proportional to physical dimensions of a display interface that the web element is displayed on. However, a user of an electronic device with a small display interface may have a difficult time interacting with the web element.

### SUMMARY

The disclosed subject technology relates to a computer-implemented method for providing web content for display. The method comprises receiving an indication to display a web element on a display interface of an electronic device. The method further comprises receiving a physical dimension requirement for the web element. The method further comprises obtaining, in response to receiving the indication, one or more physical dimensions of the display interface of the electronic device. The method further comprises displaying the web element based on the one or more physical dimensions of the display interface of the electronic device and on the received physical dimension requirement of the web element.

The disclosed subject technology further relates to a system for providing web content for display. The system includes one or more processors, and a machine-readable medium including instructions stored therein, which when executed by the processors, cause the processors to perform operations comprising receiving an indication to display a web element on a display interface of an electronic device. The operations further comprise receiving a physical dimension requirement for the web element. The operations further comprise obtaining, in response to receiving the indication, one or more physical dimensions of the display interface of the electronic device, wherein the physical dimension requirement of the web element and the one or more physical dimensions of the display interface are based on an international system of units. The operations further comprise displaying the web element based on the one or more physical dimensions of the display interface of the electronic device and on the received physical dimension requirement of the web element.

The disclosed subject technology further relates to a machine-readable medium including instructions stored therein, which when executed by a system, cause the system to perform operations including receiving an indication to display a web element on a display interface of an electronic device. The operations further comprise receiving a physical dimension requirement for the web element. The operations further comprise obtaining, in response to receiving the indication, one or more physical dimensions of the display interface of the electronic device. The operations further comprise determining, based on the one or more physical dimensions of the display interface, a device pixel ratio that is compatible with the electronic device. The operations further comprise displaying the web element based on the one or more physical dimensions of the display interface of the electronic device, on the received physical dimension requirement of the web element, and on the determined device pixel ratio of the electronic device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

It is to be understood that both the foregoing general description and the following detailed description are exemplary and explanatory and are intended to provide further explanation of the subject technology as claimed.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for providing web content for display.

FIG. 2 illustrates an example process for providing web content for display.

FIG. 3A is an example illustration of a screenshot of web content as displayed on a tablet computer.

FIG. 3B is an example illustration of a screen of the web content of FIG. 3A as displayed on a smartphone.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In accordance with the subject disclosure, a system and a method for displaying web content are provided. According to example aspects, web content includes but is not limited to any combination of audio-content items, text-based content items, video content items, audiovisual content items, etc, where each content item of the web content is associated with a respective web element. An indication to display a web element on an display interface of an electronic device is received by the electronic device. A physical dimension requirement for the web element is also received. The physical dimension requirement may specify minimum dimensions for the web element, maximum dimensions for the web element, etc. In one example aspect, a user-selectable control (e.g., a button, a tab, etc.) that is displayed on a touchscreen interface of a touchscreen device (e.g., smartphone, tablet computer, etc.) may be difficult to select via the touchscreen interface of the touchscreen device. In this case, the physical dimension requirement specifies minimum physical dimensions for the user-selectable control that would allow the user to comfortably select via the touchscreen interface.

According to example aspects, a physical unit of measurement (e.g., mm, cm, etc.) rather than a relative unit of measurement (e.g., a cascading style sheet unit of measurement which assumes that the display interface has a pixel density of 96 dots per inch) is used to specify the minimum and maximum dimensions of the web element. In this regard, a physical unit of measurement, unlike a relative unit of measurement, does not take into account device specific variables (e.g., pixel density of a display interface), instead provides a uniform unit of measurement for the web element that is device independent.

The physical dimension requirement for the web element may vary based on a type of the web element. In example aspects, the physical dimension requirement for an input box and the physical dimension requirement for a button are different. In example aspects, the physical dimension requirement may be specified in increments of inches, millimeters, or another unit of length. The physical dimension requirement for the web element may also vary based on a type of electronic device the web element is provided for display on.

Physical dimensions of the display interface of the electronic device are determined in response to receiving the indication. Additional specifications of the electronic device such as device pixel ratio of the electronic device and scaling factor for web elements that are displayed on the electronic device may also be determined. As used herein, device pixel ratio encompasses its plain and ordinary meaning including, but not limited to, a ratio between physical pixels and device-independent pixels on an electronic device. The web element is then provided for display based on the physical dimensions of the display interface of the electronic device and on the received physical dimension requirement of the web element. For example, if the physical dimension requirement for the web element specifies minimum dimensions for the web element, then the web element may be scaled to encompassing physical dimensions that are greater than or equal to the specified minimum dimensions.

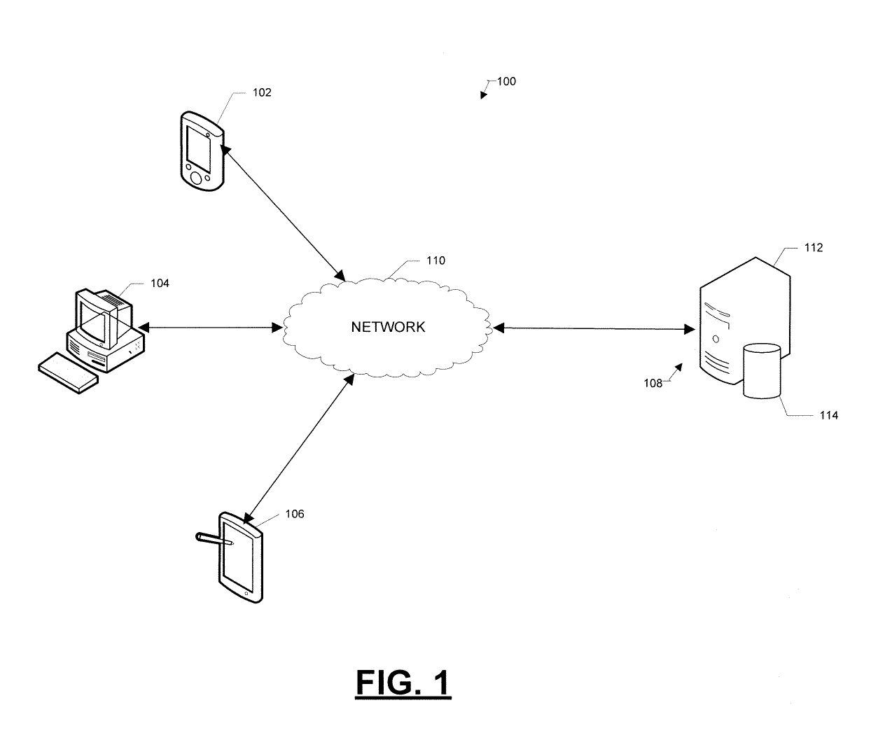

FIG. 1 illustrates an example network environment for providing web content for display. A network environment 100 includes electronic devices 102, 104, and 106 communicably connected to a server 108 by a network 110. Server 108 includes a processing device 112 and a data store 114. Processing device 112 executes computer instructions stored in data store 114, for example, to provide web elements to electronic device 102, 104, or 106.

In some example aspects, each of the electronic devices 102, 104, or 106 may include any machine that can provide for display, web elements that have different physical dimensions. Electronic devices 102, 104, and 106 can be mobile devices (e.g., smartphones, tablet computers, PDAs, and laptop computers), portable media players, desktop computers, televisions, or other appropriate computing devices. In the example of FIG. 1, electronic device 102 is depicted as a smartphone, electronic device 104 is depicted as a desktop computer, and electronic device 106 is depicted as a tablet computer.

Server 108 may be any system or device having a processor, memory, and communications capability to provide web elements to electronic device 102, 104, or 106. Server 108 may be a single computing device such as a computer server. Server 108 may also represent more than one computing device working together to perform the actions of a server computer.

An electronic device 102, 104, or 106 requests server 108 to transmit web content to the electronic device. Web content includes but is not limited to any combination of audio-content items, text-based content items, video content items, audiovisual content items, etc, where each content item of the web content is associated with a respective web element. The electronic device receives an indication to display a web element associated with the web content on a display interface of the electronic device. The indication may be generated by the electronic device in response to receiving the requested web content. This indication may also be transmitted from server 108 together with the requested web content.

The electronic device receives physical dimension requirements for the web element. Physical dimension requirements may specify minimum dimensions of the web element, maximum dimensions of the web element, etc. According to example aspects, an international system of units (e.g., mm, cm, etc.) is used to specify the minimum and maximum dimensions of the web element. The physical dimension requirements may be locally stored in a hardware component of the electronic device or stored in a storage location on server 108. According to example aspects, the physical dimension requirements for the web element may vary based on a type of web element. According to other example aspects, physical dimension requirements for the web element are based on a type of the electronic device the web element is provided for display on.

The electronic device also obtains physical dimensions of the display interface of the electronic device. The electronic device, determines, based on the physical dimensions of the display interface of the electronic device and on the received physical dimension requirements of the web element, dimensions for the web element. The electronic device then displays the web element, where the displayed web element has the determined dimensions.

Network 110 can include, for example, any one or more of a cellular network, a satellite network, a personal area network (PAN), a local area network (LAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

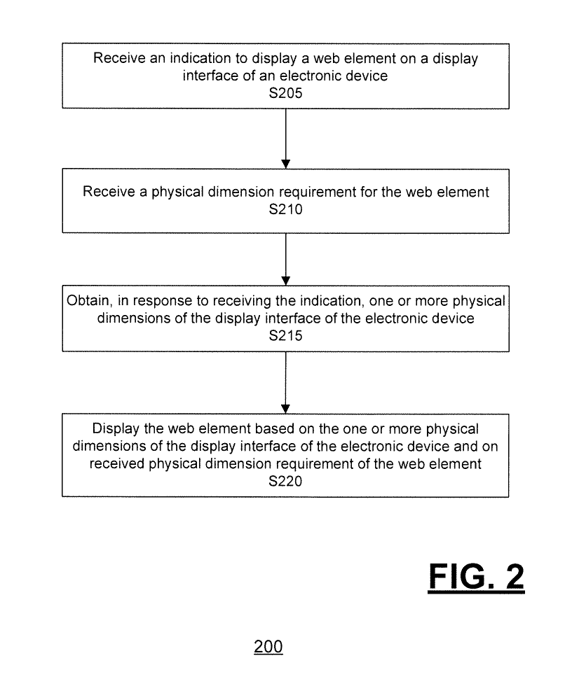

FIG. 2 illustrates an example process for providing web content for display. Although the operations in process 200 are shown in a particular order, certain operations may be performed in different orders or at the same time. In addition, although process 200 is described with reference to the system of FIG. 1, process 200 is not limited to such and can be performed by other system(s).

In block S205, an electronic device 102, 104, or 106 receives an indication to display a web element on a display interface. According to example aspects, the web element is associated with a content item (e.g., an audio-content item, a text-based content item, a video content item, an audiovisual content item, etc.) and is displayed on the electronic device. According to other example aspects, the web element is associated with a user-selectable control (e.g., a button, a control, a tab, a switch, etc.).

In block S210, the electronic device receives a physical dimension requirement for the web element. The physical dimension requirement of the display interface may be obtained from a hardware component of the electronic device (e.g., RAM, ROM, etc.) or from storage on server 108. The physical dimension requirement may specify minimum dimensions for the web element, maximum dimensions for the web element, etc. In example aspects, the physical dimension requirement may be specified in increments of inches, millimeters, or another unit of length. The physical dimension requirement for the web element may also vary based on a type of electronic device the web element is provided for display on. For example, the physical dimensions of the web element may be proportional to the physical dimensions of the display interface of the electronic device. In this case, the web element may have greater physical dimensions if it is displayed on a tablet computer and smaller physical dimensions if it is displayed on a smartphone. Web elements (buttons, tabs, etc.) may be difficult for the user to select on a display screen (e.g., a touchscreen interface, etc.) if their physical dimensions are below a threshold. In this case, the physical dimension requirement specifies minimum physical dimensions for the web elements to ensure that the user may comfortably select the web elements on the display screen.

In block S215, the electronic device obtains physical dimensions of the display interface in response to receiving the indication. The physical dimensions of the display interface may be obtained from a hardware component of the electronic device or from storage on server 108. The electronic device may also determine, based on the physical dimensions of the display interface, a device pixel ratio that is compatible with the display interface of the electronic device. The electronic device may determine, based on the physical dimension requirement of the web element and the physical dimensions of the display interface, dimensions for the web element. In block S220, the electronic device displays the web element based on the one or more physical dimensions of the display interface and the received physical dimensions requirement of the web element.

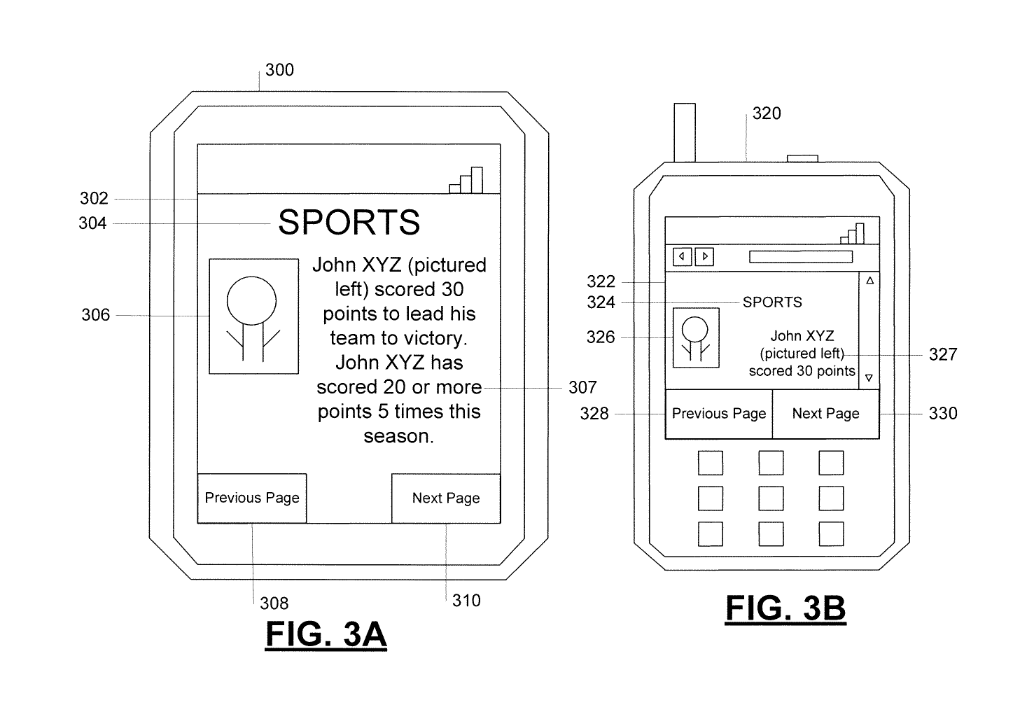

FIG. 3A is an example illustration of a screenshot of web content as displayed on a tablet computer. As shown in FIG. 3A, multiple web elements 304, 306, 308, and 310 associated with web content for a webpage are displayed on display interface 302 of tablet computer 300. In the example of FIG. 3A, an indication to display web elements 304, 306, 308, and 310 is received by the tablet computer in response to a user input of a URL for a webpage the web elements are associated with. The table computer also receives physical dimension requirements for each of the web elements.

The physical dimension requirements may specify minimum dimensions and maximum dimensions for each of the web elements in increments of inches, millimeters, or another physical unit of length. A physical unit of measurement, unlike a relative unit of measurement (e.g., a cascading style sheet unit of measurement which assumes that the display interface has a pixel density of 96 dots per inch), does not take into account of device specific variables (e.g., pixel density of a display interface), instead provide a uniform unit of measurement for the web element that is device independent. Accordingly, a web element that has physical dimensions specified by a physical unit of measurement has a uniform display size across different types of electronic devices. In the example of FIG. 3A, the physical dimension requirements for graphical content item 306 specifies that the content item must be at least Amm by Bmm and the physical dimension requirements for user-selectable controls 308 must be at least Xmm by Ymm. The physical dimension requirements for web elements 304, 306, 308, and 310 may be stored locally on a hardware component of the tablet computer, or stored on a storage component (e.g., data store, etc.) of server 108.

The tablet computer 300 also obtains one or more physical dimensions of display interface 302 of the tablet computer 300. In the example of FIG. 3A, display interface 302 may have a width of 120 mm and a height of 80 mm. According to example aspects, the tablet computer determines, based on the physical dimensions of display interface 302, a device pixel ratio that is compatible with the display interface of the tablet computer. The tablet computer may also determine, based on the physical dimension requirements of each of web elements 304, 306, 308, and 310 and the physical dimensions of the display interface, respective dimensions for each of the web elements.

The web elements are then displayed on display interface 302 of tablet computer 300. According to example aspects, different web elements that represent different types of content items may be provided for display on display interface 302 of the tablet computer. In the example of FIG. 3A, web elements for the displayed webpage include text-based content items 304 and 307, a graphical content item 306, and user-selectable controls 308 and 310. As shown in FIG. 3A, text-based content items 304 and 307 have different display sizes and user-selectable controls 308 and 310 have identical display sizes. The display size of each of the user-selectable controls of FIG. 3A is based on the dimensions of display interface 302 and physical dimension requirements of each of the respective content items. In the example of FIG. 3A, graphical content item 306 may have a display size of 40 mm by 20 mm and user-selectable controls 308 and 310 may each have a display size of 15 mm by 30 mm.

FIG. 3B is an example illustration of a screen of the web content of FIG. 3A as displayed on a smartphone. Display interface 322 of smartphone 320 provides for display the web elements that are also displayed on display interface 302 of tablet computer 300. In the example of FIG. 3B, display interface 322 may have a width of 90 mm and a height of 60 mm. In this case, interface 322 has physical dimensions that are seventy-five percent of corresponding dimensions of display interface 302. Accordingly, physical dimensions of some of the web elements that are displayed on tablet computer 300 have been resized based on physical dimensions of smartphone device 320. In the example of FIG. 3B, physical dimensions of graphical content item 326 are 30 mm by 15 mm, which correspond to seventy-five percent of the physical dimensions of graphical content item 306. As shown in FIG. 3B, text-based content items 324 and 327 have smaller physical dimensions compared to corresponding text-based content items 304 and 307, which are displayed on display interface 302 of tablet computer 300.

Some web elements (e.g., user-electable controls 328 and 330) may be designated to have minimum dimensions regardless of physical dimensions of the electronic device. For example, user-selectable controls 328 and 330 may be difficult to select via display interface 322 if the physical dimensions of their respective display size are below a certain threshold. In this case, the physical dimension requirement specifies minimum physical dimensions for user-selectable controls 328 and 330 that would allow the user to comfortably select user-selectable controls 328 and 330 via display interface 322.

In the example of FIG. 3A, the physical dimension requirement for user-selectable controls 308 and 310 ensures that user-selectable controls 308 and 310 are displayed at a display size that at a minimum, allows the user to comfortably select the respective user-selectable controls regardless of the electronic device the respective user-selectable controls are displayed on. As shown in FIG. 3A, user-selectable controls 308 and 310 are displayed at minimum-dimensions, and reducing the size of display interface 302 would not reduce the size of the user selectable controls. Therefore, physical dimensions of user-selectable controls 328 and 330 have identical dimensions compared to corresponding user-selectable controls 308 and 310 of FIG. 3A even though the physical dimensions of display interface 322 of smartphone 320 is less than the physical dimensions of display interface 302 of tablet computer. In the example of FIG. 3B, physical dimensions of user-selectable controls 328 and 330 are 15 mm by 30 mm, which are identical to physical dimensions of user-selectable controls 308 and 310, even though user-selectable controls 328 and 330 are displayed on a smaller display interface.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

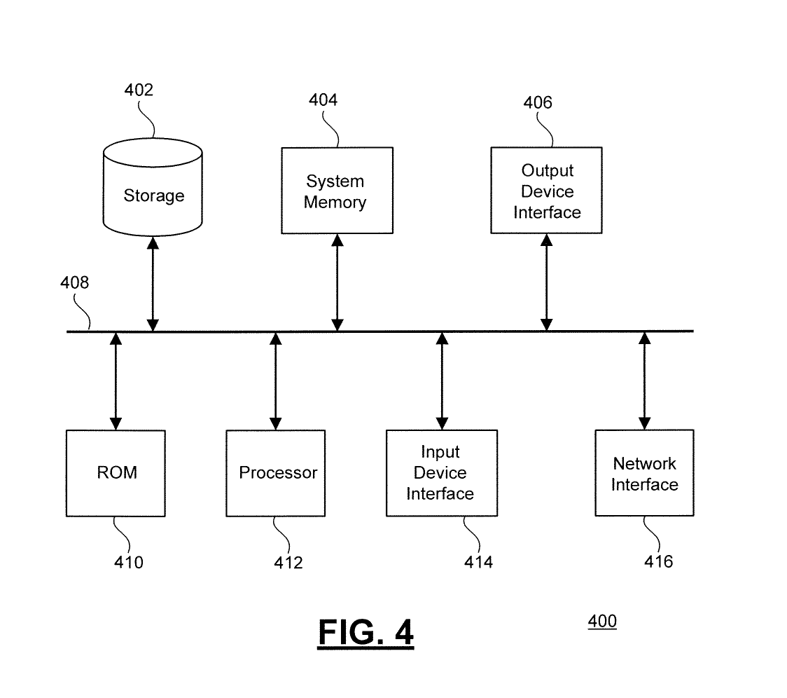

FIG. 4 conceptually illustrates an electronic system with which some implementations of the subject technology are implemented. Electronic system 400 can be a laptop computer, a desktop computer, smartphone, PDA, a tablet computer or any other sort of device 102, 104, and 106. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's electronic device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to an electronic device (e.g., for purposes of displaying data to and receiving user input from a user interacting with the electronic device). Data generated at the electronic device (e.g., a result of the user interaction) can be received from the electronic device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method for providing web content for display, the method comprising:
receiving an indication to display a web element on a display interface of an electronic device;
receiving a physical dimension requirement for the web element, wherein the physical dimension requirement for the web element is based on a web element type;
obtaining, in response to receiving the indication, one or more physical dimensions of the display interface of the electronic device; and
displaying the web element based on the one or more physical dimensions of the display interface of the electronic device and on the received physical dimension requirement of the web element.

2. The computer-implemented method of claim 1, wherein the physical dimension requirement of the web element and the one or more physical dimensions of the display interface are based on an international system of units.

3. The computer-implemented method of claim 1, further comprising:
determining, based on the one or more physical dimensions of the display interface, a device pixel ratio that is compatible with the electronic device, wherein displaying the web element is based on the determined device pixel ratio of the electronic device.

4. The computer-implemented method of claim 1, wherein physical dimensions of the displayed web element are proportional to the one or more physical dimensions of the display interface of the electronic device.

5. The computer-implemented method of claim 1, wherein the physical dimension requirement designates minimum physical dimensions for the web element.

6. The computer-implemented method of claim 1, wherein receiving the physical dimension requirement for the web element comprises receiving the physical dimension requirement from storage in a hardware component of the electronic device.

7. The computer-implemented method of claim 1, wherein receiving the physical dimension requirement of the web element comprises receiving the physical dimension requirement from storage on a server connected to the electronic device.

8. The computer-implemented method of claim 1, wherein the web element is a content item.

9. The computer-implemented method of claim 1, wherein the web element is a user-selectable control.

10. A system for providing web content for display, the system comprising:
one or more processors; and
a machine-readable medium comprising instructions stored therein, which when executed by the processors, cause the processors to perform operations comprising:
receiving an indication to display a web element on a display interface of an electronic device;
receiving a physical dimension requirement for the web element, wherein the physical dimension requirement for the web element is based on what type of web element the web element is;
obtaining, in response to receiving the indication, one or more physical dimensions of the display interface of the electronic device, wherein the physical dimension requirement of the web element and the one or more physical dimensions of the display interface are based on an international system of units;
displaying the web element based on the one or more physical dimensions of the display interface of the electronic device and on the received physical dimension requirement of the web element.

11. The system of claim 10, wherein the operations further comprise:
determining, based on the one or more physical dimensions of the display interface, a device pixel ratio that is compatible with the electronic device, wherein displaying the web element is based on the determined device pixel ratio of the electronic device.

12. The system of claim 10, wherein physical dimensions of the displayed web element are proportional to the one or more physical dimensions of the display interface of the electronic device.

13. The system of claim 10, wherein the physical dimension requirement designates minimum dimensions for the web element.

14. The system of claim 10, wherein receiving the physical dimension requirement for the web element comprises receiving the physical dimension requirement from storage in a hardware component of the electronic device.

15. The system of claim 10, wherein receiving the physical dimension requirement of the web element comprises receiving the physical dimension requirement from storage on a server connected to the electronic device.

16. The system of claim 10, wherein the web element is a content item.

17. The system of claim 10, wherein the web element is a user-selectable control.

18. A non-transitory machine-readable medium comprising instructions stored therein, which when executed by a system, cause the system to perform operations comprising:
receiving an indication to display a web element on a display interface of an electronic device;
receiving a physical dimension requirement for the web element, wherein the physical dimension requirement for the web element varies based on a web element type;
obtaining, in response to receiving the indication, one or more physical dimensions of the display interface of the electronic device;
determining, based on the one or more physical dimensions of the display interface, a device pixel ratio that is compatible with the electronic device; and
displaying the web element based on the one or more physical dimensions of the display interface of the electronic device, on the received physical dimension requirement of the web element, and on the determined device pixel ratio of the electronic device.

19. The machine-readable medium of claim 18, wherein the physical dimension requirement of the web element and the one or more physical dimensions of the display interface are based on an international system of units.

20. The machine-readable medium of claim 18, wherein physical dimensions of the displayed web element are proportional to the one or more physical dimensions of the display interface of the electronic device.
